(19) United States
(12) Patent Application Publication
(10) Pub. No.: US 2026/0366510 A1
(43) Pub. Date: Nov. 19, 2026

(54) METHOD OF BOOSTING AN ELECTRIC MOTOR OF A MOBILE COMPRESSOR AND SUCH COMPRESSOR

(71) Applicant: ATLAS COPCO AIRPOWER, NAAMLOZE VENNOOTSCHAP, Wilrijk (BE)

(72) Inventors: Stefan VELGHE, Wilrijk (BE); Ivo DANIËLS, Wilrijk (BE)

(73) Assignee: ATLAS COPCO AIRPOWER, NAAMLOZE VENNOOTSCHAP, Wilrijk (BE)

(21) Appl. No.: 19/477,423

(22) PCT Filed: Apr. 12, 2024
(86) PCT No.: PCT/IB2024/053591

§ 371 Date: Oct. 21, 2025

(30) Foreign Application Priority Data
Apr. 28, 2023 (BE) BE20235341

(51) Int. Cl. F04C 28/08; F04B 35/06; F04B 49/06; F04C 18/16; F04C 23/02; H02J 7/34

(52) U.S. Cl. CPC F04C 28/08; F04B 35/06; F04B 49/065; F04C 18/16; F04C 23/02; H02J 7/34; F04C 2270/02; F04C 2270/18; F04C 2270/20

(57) ABSTRACT

An electrically powered mobile compressor including an electric motor for driving a compressor element for supplying a compressed gas and further including an electrical connection for a electricity grid. The electric motor is connected to an electrical distribution device and further to an on-board charger to provide electric power to the electrical distribution device, a battery management system for supporting a power exchange between the distribution device and rechargeable batteries, and a controller configured to coordinate a power exchange between the electricity grid, the assembly of one or more rechargeable batteries, and the electric motor. When a required power for the electric motor exceeds an available power from the electricity grid, it is complemented with a power from the batteries.

### TECHNICAL FIELD

The present invention relates to an electrically powered compressor and to a method for controlling such an electrically powered compressor.

### STATE OF THE ART

A compressor is a machine, designed to produce compressed gases, such as compressed air. The compressed gas at a certain working pressure is then used in a range of applications, such as powering other machines such as pneumatic jackhammers and drills.

Such jackhammers and drills are usually used on locations where no permanent compressed air network is present, such as a construction site. Typically, a mobile compressor is used on these locations. The term mobile is therefore understood to mean that such a compressor can be moved, with or without the aid of transport means and/or hoisting means. In other words, a mobile compressor is a compressor that is not designed to be used stationary in a fixed location.

Mobile compressors can be driven by a diesel engine such that they can operate independently. However, as they emit combustion gases and are noisy, there is a tendency to replace these diesel engines with an electric motor. An electricity grid must then be present to drive this electric motor.

Such an electrically powered mobile compressor is disclosed in BE1024040A1. The mobile compressor is equipped with a control unit to limit the maximum electrical current consumed to an adjustable maximum value. This prevents the electricity grid, to which the mobile compressor is connected, from being overloaded.

As further disclosed in BE1024040A1, the energy supply from the electricity grid can be further complemented with a set of batteries. When the mobile electrically powered compressor is not active but connected to the electricity grid, the batteries can be charged. When the mobile electrically powered compressor is operational, the electrical mobile compressor can draw electrical power from the electricity grid. If the grid were to fail, work can continue using power that can be withdrawn from the charged batteries.

However, if the required power for the electric motor exceeds the available power from the electricity grid, a higher electrical current will be withdrawn from the grid than that for which the grid is dimensioned and therefore protected. If overcurrent protection is functioning correctly, the compressor will be switched off immediately by switching off the electric motor. However, such an abrupt shutdown can lead to a dangerous situation as an operator generally cannot anticipate this. In addition, if overcurrent protection functions poorly, an excessive load can lead to damage to the electricity grid.

A disadvantage of the electrically powered mobile compressors and associated methods as known in the state of the art is that the existing electricity grid is the limiting factor. In other words, the applications for which the compressed gas will be used are limited by the available power of the electricity grid. However, this available power is generally a fixed value and not easy to increase.

Therefore, it is an objective of the present invention to provide a device and method that overcomes one or more of the described disadvantages of prior art solutions. More specifically, it is an object of the present invention to provide a device and method that results in larger available power for an electrically powered mobile compressor.

### SUMMARY OF THE INVENTION

According to the present invention, the above-identified objective is achieved by providing, according to a first aspect of the invention, a computer-implemented method according to the first claim for controlling an electrically powered mobile compressor, comprising a compressor element driven by an electric motor, for supplying a compressed gas at a predefined pressure and/or flow rate, the electric motor connected to an electrical distribution device for providing an electrical consumer current, the distribution device further comprising:
an on-board charger, configured to provide electrical power to the electrical distribution device from an electricity grid; and
a battery management system, configured to support power exchange between the distribution device and an assembly of one or more rechargeable batteries;
a controller, configured to coordinate a power exchange between the electricity grid, the assembly of one or more rechargeable batteries, and the electric motor;
   the method comprising the step of, when a required power for the electric motor exceeds an available power from the electricity grid;
complementing the available power with power from the assembly of one or more rechargeable batteries.

The electrically powered mobile compressor is configured to provide compressed air at a location where generally no compressed air network is available. On the other hand, an electricity grid is available to power the compressor. This electricity grid is, for example, a low-voltage grid at a certain voltage, such as 400 V which is common in Europe, or 480 V which is common in the United States of America. It should therefore be understood that the value of the voltage to which the mobile compressor can be connected is not limiting, but can be adapted to the region where the compressor will be used. Furthermore, this electricity grid is characterized by an available electrical power, which in turn determines a maximum current that can be withdrawn from the electricity grid in a safe manner.

The compressor is further equipped with an electric motor to drive a compressor element. For example, the compressor element is a screw when the compressor is of the screw compressor type. Here too, it is further understood that the type of compressor element is not limiting and that other compressor elements can be used to supply the compressed gas at a predefined pressure. The value of this pressure further depends on the intended applications and can also be adjustable.

Furthermore, a mechanical coupling between the electric motor and the driven compressor element, such as a gearbox, may be present. In other words, the drive of the compressor element does not have to be directly driven by the electric motor, but a mechanical coupling between them can also be provided. This will convert the speed of the electric motor into a speed suitable for the compressor element.

Moreover, the type of electric motor is also not limiting for the disclosed invention. This can be a three-phase asynchronous electric motor, as well as a three-phase permanent magnet synchronous motor. In these cases, a frequency converter will be present between the electrical distribution system and the motor. This frequency converter, also called a frequency controller, inverter, or variable speed drive, VSD, will then convert a direct voltage from the electrical distribution device to an alternating voltage with a certain frequency, suitable for the three-phase electric motor. Furthermore, both the frequency and the alternating voltage can change in order to deliver a certain torque to the compressor element, depending on the required pressure of the compressed gas.

Alternatively, the electric motor can be of the direct current motor type. The direct current motor can then be directly connected to the electrical distribution device, but as a rule, a DC/DC converter will be present between the electrical distribution device and the direct current motor to be able to apply a terminal voltage suitable therefor.

In addition, also several electric motors may be present, each of which individually drives a compressor element. A frequency controller can then be provided for each electric motor. Another possible configuration is that a single electric motor drives two or more compressor elements. When reference is made to a current for the electric motor, this also refers to the total electrical current required to drive the one or more motors.

The current that then flows between the electrical distribution device and the electric motor is further referred to as the electrical consumer current, or consumer current for short. Furthermore, note that this consumer current is also the current required to drive the compressor element when the compressor is operational.

The electrical distribution device is a voltage rail, also called a busbar, to distribute electricity between the various connected devices. A first device is the electric motor just discussed. The consumer current then flows from the electrical distribution device to the electric motor.

A second device, connected to the electrical distribution system, is an on-board charger. The on-board charger is configured to convert electrical power from the electricity grid to a suitable value and make it available to the electrical distribution device. Usually, an alternating current from the electricity grid will be converted into a direct current. In this case, an electrical current will flow from the electricity grid through the on-board charger to the electrical distribution device to make this electrical power available to the various electrical consumers connected to it.

Another device, connected to the electrical distribution system, is a battery management system. The battery management system is configured to support a power exchange between the distribution device and an assembly of one or more rechargeable batteries by monitoring the state of charge of this assembly. To support this, the current, voltage and temperature of one or more batteries are measured and data is exchanged with the on-board charger based thereon, possibly after one or more calculations. This allows the power exchange to take place in an optimal manner. The battery management system will also comprise a safety function to protect the batteries by not discharging them too deeply. Discharging takes place, for example, when another electrical consumer, such as the electric motor to drive the compressor element, connected to the electrical distribution device, consumes electrical power when no electricity grid is available.

In other words, the battery management system is a system as known in the state of the art. It will therefore ensure that the batteries are kept in a safe and reliable condition. This is done, among other things, by monitoring the state of charge and ensuring that the batteries are not discharged too deeply, as will be explained further.

The connected set of rechargeable batteries is further characterized by a maximum charging current. This is the maximum value of current with which the batteries can be charged in a safe and efficient manner. As will be explained further, this value depends on the state of charge of the set of batteries. In principle, however, this will be regarded as a fixed value.

The controller is configured to coordinate a power exchange between the electricity grid, the assembly of one or more rechargeable batteries, and the electric motor. The controller does this on the basis of data, exchanged with the battery management system and the on-board charger, and on the basis of the required power of the electric motor. This power can be determined, based on data exchanged with the electric motor, and/or via a separate current measurement.

Furthermore, according to a new and innovative concept, the method comprises the step of, when a required power for the electric motor exceeds an available power from the electricity grid;
complementing the available power with power from the assembly of one or more rechargeable batteries.

If the electric motor requires a larger electrical demand current than that which the electricity grid can supply, this will be complemented with an electrical current originating from the assembly of one or more rechargeable batteries.

An advantage is that the available power of the electricity grid is not limiting. As long as there is sufficient power in the assembly of batteries, the compressor can be used at a higher power than that made available by the electricity grid.

A first situation, for example, is one wherein the nominal power of the electric motor is larger than the available nominal power of the electricity grid. When the batteries are sufficiently charged, the compressor can be used at its nominal power for a considerable period of time. This can happen as long as the assembly of batteries can complement the difference between the nominal power of the electric motor compared to the electricity grid.

A second situation is one, where the available nominal power from the electricity grid is sufficient compared to the nominal power of the electric motor, but the electric motor is temporarily overloaded. In other words, the power of the motor and the power of the electricity grid are matched, but it is desired to temporarily overload the electric motor to a allowable value and for a certain time according to the specified specifications of this electric motor. The extra power can then be supplied by the batteries. This prevents the overcurrent protection of the connection to the electricity grid from being triggered and thus the electrical current from the grid from being interrupted.

According to a preferred embodiment, the method further comprises the step of determining a state of charge of the assembly of the one or more rechargeable batteries, indicative of a remaining power using the battery management system and wherein the step of completing takes place as long as the state of charge is higher than a first predefined value.

In other words, the controller is further configured to complement the required power, based on the state of charge of the assembly of rechargeable batteries, with a current from this assembly of rechargeable batteries as long as the state of charge and therefore the power thereof is above a first predefined value. This will protect the assembly of batteries such that they are not discharged too deeply. Furthermore, according to a subsequent embodiment, the required power of the electric motor can also be limited when the state of charge of the assembly of rechargeable batteries is lower than a second predefined value. Limiting then comprises imposing an upper limit on the power consumption of the electric motor, which also limits and therefore reduces the electrical current consumed. Preferably, the second predefined value is higher than the first predefined value, or in other words, the first predefined value is lower than the second predefined value. This means that the second predefined value corresponds to a higher charge state than that corresponding to the first predefined value.

By limiting the power, required for the electric motor when the second value is reached, the assembly of batteries will discharge less quickly, thereby extending the time period within which the compressor can be used at a higher power than provided by the electricity grid. When the first value is reached, complementing can then be switched off completely, limiting the power of the electric motor to the available power from the electricity grid. Then, a situation may arise that the first and the second predefined values are equal to each other, wherein, when the second predefined value is reached, the step of complementing is immediately stopped because simultaneously the first predefined value is reached, because in this situation they are the same.

Limiting the required power of the electric motor can be done, for example, by limiting the predefined pressure and/or flow rate.

Furthermore, according to an embodiment, the electrical distribution device may further comprise a connection for an electrical consumer, wherein the method then further comprises the step of limiting an electrical demand current from this electrical consumer when the required power for the electric motor exceeds the available power from the electricity grid. This connection is, for example, a socket to which an electrical appliance can be connected. The electrical current that this device consumes is referred to as the electrical demand current, or simply demand current. When the available power is insufficient to supply both the power for the electric motor and the demand power, it will be complemented with electric power from the batteries, just as when no additional connection is present. Again, this is done on the basis of the charge status of the assembly of the rechargeable batteries. When the state of charge is lower than the second predefined value, the required power for the electric motor will be limited. In other words, when insufficient electrical power is available, the power for the compressor is limited, while the demand power continues to be provided.

According to a second aspect of the invention, an electrically powered mobile compressor for driving a compressor element for supplying a compressed gas at a predefined pressure and/or flow rate is disclosed, the compressor further comprising an electrical connection for an electricity grid, the electric motor connected to an electrical distribution device, the electrical distribution device further comprising:
an on-board charger, configured to provide electrical power to the electrical distribution device from the electricity grid; and
a battery management system, configured to support power exchange between the distribution device and an assembly of one or more rechargeable batteries;
a controller, configured to coordinate a power exchange between the electricity grid, the assembly of one or more rechargeable batteries, and the electric motor;
   wherein the controller is further configured to control the battery management system such that, when a required power for the electric motor exceeds an available power from the electricity grid, the available power is complemented with a power from the assembly of one or more rechargeable batteries.

In other words, the controller is configured to perform the computer-implemented method and associated steps according to the first aspect of the invention. This further means that, according to an embodiment, the controller is configured to determine a state of charge of the assembly of the one or more rechargeable batteries, indicative of a remaining power, using the battery management system, and wherein the available power is complemented as long as the state of charge is higher then a first predefined value.

Furthermore, the controller may be configured to limit the required power by the electric motor when the state of charge is lower than a second predefined value. The first predefined value can be less than or equal to the second predefined value.

The controller is further configured, according to an embodiment, to limit the required power for the electric motor by limiting the predefined pressure and/or flow rate.

Furthermore, the electrical distribution device of the electrically powered mobile compressor may comprise a connection for an electrical consumer, and the controller is further configured, when the required power for the electric motor and the electric consumer exceeds the available power from the electricity grid, to limit the required power for the electric motor when the state of charge is lower than a second predefined value.

According to a third aspect of the invention, a controller, configured to perform the computer-implemented method according to the first aspect of the invention, is disclosed.

According to a fourth aspect of the invention, a data processing system comprising a processing unit, configured to perform the method according to the first aspect of the invention, is disclosed.

According to a fifth aspect of the invention, a computer program product containing computer-executable instructions to perform the method of the first aspect when executed on a computer, is disclosed.

According to a sixth aspect, a computer-readable storage medium containing the computer program product according to the fifth aspect, is disclosed.

### BRIEF DESCRIPTION OF THE DRAWINGS

The invention will be further illustrated with reference to the figures, wherein

FIG. 1 schematically illustrates an electrical distribution device with an electric motor, an on-board charger, and a battery with a battery management system connected thereto; and

FIG. 2 schematically illustrates an electrical distribution device as in FIG. 1 with an electrical consumer connected to it; and

FIG. 3 illustrates an electrically powered mobile compressor comprising the electrical distribution device as shown in FIG. 1 or FIG. 2; and

FIG. 4 illustrates the course of the consumer current, the maximum charging current, and a discharge current in different operating modes; and

FIG. 5 schematically illustrates different operating modes.

### DETAILED DESCRIPTION OF THE EMBODIMENTS

The present invention will be described with respect to certain embodiments and with reference to certain drawings, but the invention is not limited thereto and is determined only by the claims. The drawings described are only schematic and non-limiting. In the drawings, the size of certain elements may be exaggerated and not drawn to scale for illustrative purposes. The dimensions and relative dimensions do not necessarily correspond to actual practical embodiments of the invention.

Furthermore, the terms first, second, third and the like are used in the description and in the claims to distinguish between similar elements and not necessarily to describe a sequential or chronological order. The terms are interchangeable under appropriate circumstances and the embodiments of the invention may be practiced in sequences other than those described or illustrated herein.

In addition, the terms above, below, over, below and the like in the description and claims are used for illustrative purposes and not necessarily to describe relative positions. The terms thus used are interchangeable under appropriate circumstances and the embodiments of the invention described herein may be employed in orientations other than those described or illustrated herein.

Furthermore, the various embodiments, although referred to as “preferred embodiments”, are to be construed as exemplary means of carrying out the invention rather than as a limitation of the scope of the invention.

The term “comprising” used in the claims should not be construed as being limited to the means or steps set forth below; the term does not exclude other elements or steps. The term should be interpreted as specifying the presence of the mentioned features, elements, steps or components referred to, but does not exclude the presence or addition of one or more other features, elements, steps or components, or groups thereof. The scope of the expression “a device comprising means A and B” should therefore not be limited to devices consisting only of components A and B. The meaning is that with respect to the present invention only components A and B of the device are listed, and the claim is further construed to also include equivalents of these components.

When referring to electrical currents and more specifically their values, it should be understood that these currents can refer to both alternating and direct current, and it can be deduced from the context which type of current is meant. As a rule, an alternating current is drawn from the electricity grid, while a charging and/or discharging current from the assembly of the rechargeable batteries is of the direct current type. The electric motor can have both direct and alternating current, which depends on the type of motor. If an electrical consumer is present, both direct and alternating current can also be present, but, as a rule, this will be alternating current.

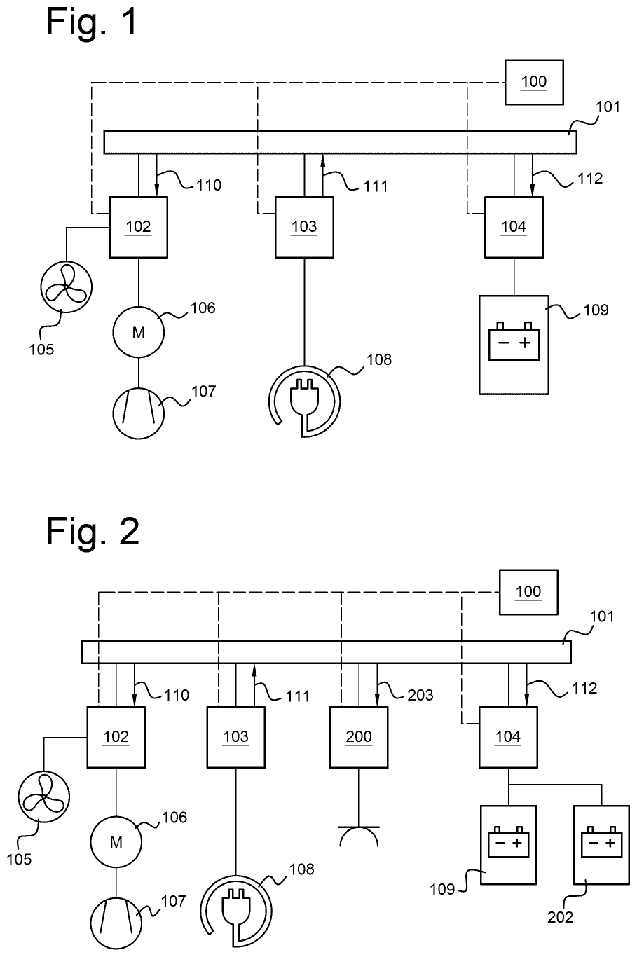

FIG. 1 schematically illustrates an electrical distribution device 101 with an electric motor 106, an on-board charger 103, and a battery management system 104 with a set of batteries 109 connected thereto. Furthermore, an electrical connection 108 to an external electricity grid, a controller 100, an inverter 102, a compressor element 107, and a fan 105 is illustrated.

In FIG. 2, the same electrical distribution device 101 as in FIG. 1 is illustrated with an additional electrical converter 200 and an electrical connection 201, such as, for example, a socket, to which an electrical consumer can be connected.

The electrical distribution device 101, also called a busbar, serves as a distribution board to distribute electrical power among the consumers, such as the electric motor 106, the batteries 109, and an electrical consumer connected to the electrical connection 201, when present. The electrical power, present on the distribution device 101, is of the direct voltage type.

Again with reference to FIG. 1, the inverter 102 serves to convert the direct voltage from the distribution device 101 into a voltage suitable for the electric motor 106. The inverter 102 is, for example, a frequency converter, also called a frequency controller, inverter, or variable speed drive, VSD, when the electric motor 106 is a three-phase motor, and suitable for connection to a direct current voltage source with a value in a range of, for example, 441 to 715 V_{DC}. The inverter can also be a DC/DC converter when the electric motor 106 is a direct current motor.

The electric motor 106 then drives the compressor element 107 to provide a compressed gas, usually ambient air for a mobile compressor, at a predefined pressure or flow rate. The motor is, for example, a three-phase asynchronous motor with a power of 33 kW.

Although not illustrated, there may also be a mechanical coupling between the electric motor 106 and the compressor element 107. This coupling is, for example, a gearbox and then ensures that the speed of the electric motor 106 is converted into a speed, suitable for driving the compressor element 107.

Furthermore, the compressor can be provided with a fan 105, also connected to the inverter, as a cooling system for the electric motor 106 and/or the compressor element 107. The fan 105 is, for example, powered with a voltage of 28 V. Note that other cooling systems can also be provided. It is further understood that the current to power the electric motor, as discussed further, also includes a current to power the fan 105, or an alternative cooling system.

Alternatively, the cooling system can comprise a fan that is connected to the distribution device 101 via its own inverter. In that case, there will be an additional demand current that must be taken into account. This own inverter can be the inverter 200, wherein the fan is connected to the available socket 201 and the fan determines the demand current.

The on-board charger 103 is a device that converts power, originating from an external electricity grid via the electrical connection 108 into a direct voltage, suitable for the electrical distribution device 101. The controller 100 will determine the power that must be withdrawn from the electricity grid and therefore what is the current that will flow to the electrical distribution device 101, and it will control the on-board charger 103 for this purpose. This power will be determined by the state of charge of the rechargeable batteries 109, the required power for the electric motor 106, and the current for a consumer when connected to the additional inverter 200 and connection 201.

Furthermore, the on-board charger 103 itself is also characterized by a power that it can maximally withdraw from the electricity grid. For example, the on-board charger 103 has a power of 22 kW, wherein the connection 108 to the grid is a socket with a nominal current of 32 A. Herewith, a maximum electrical power of 22 kW can be provided to the electrical distribution device 101. To expand the capacity, more than one on-board charger can be provided, each with its own connection. The controller 100 will then be configured to control multiple on-board chargers.

Again with reference to FIG. 1, the current, withdrawn from the electricity grid, is illustrated by reference numeral 111. The current, flowing to the electric motor, is illustrated by reference numeral 110, and the discharge current to withdraw power from the batteries by reference numeral 112. These currents 110-112 will then be in equilibrium when the electric motor 102 is operational and the current 110 for this consists of the sum of the current 111 from the electricity grid 108 and the current 112 from the set of batteries 109. With reference to FIG. 2, an additional current to a consumer, illustrated by reference numeral 203, may be present. The additional connection 201 is, for example, a socket with a nominal current of 32 A.

In addition, there may also be several sets of batteries present, such as, in this example, the set of batteries 202 in addition to the set already present 109. A set of batteries can then, for example, have a voltage range between 440 V and 715 V, which is in accordance with the inverter 102, such that both devices can be simultaneously connected to the electrical distribution device 101 in a safe condition.

The controller 100 is configured to communicate with the on-board charger 103. Furthermore, the controller 100 communicates with the inverter 102, and the battery management system 104. If no inverter 102 is present, i.e. in the case that the electric motor 106 is directly connected to the electrical distribution device 101, reference numeral 102 illustrates a measuring unit for determining what current 110 the electric motor 106 needs to drive the compressor element 107. It is therefore important that the controller 100 can determine what the electrical consumer current 110 is for the electric motor 106 when active.

With the help of the battery management system 104, the controller will also determine the maximum discharge current 112 in order to be able to control the electric motor 102 and provide it with electrical power using the assembly of batteries 109. For example, a maximum discharge current can be 132 A. The battery management system 104 monitors the charge status of the batteries 109 and communicates to the controller 100 what the maximum discharge current 112 is.

Subsequently, the controller 100 will control the on-board charger 103 and the battery management system 104 on the basis of the required electrical consumer current 110 for the electric motor 102, such that this current 110 can be supplied by the current 111 from the grid 108, complemented with the current 112 from the batteries 109, 202.

With the examples mentioned above, the maximum current that can be withdrawn from the grid is 128 A. Note, however, that, due to the limitation of the on-board charger power from 22 KW, the current from the grid will be limited to 32 A. It is then possible to opt to connect several on-board chargers in parallel to provide a higher current.

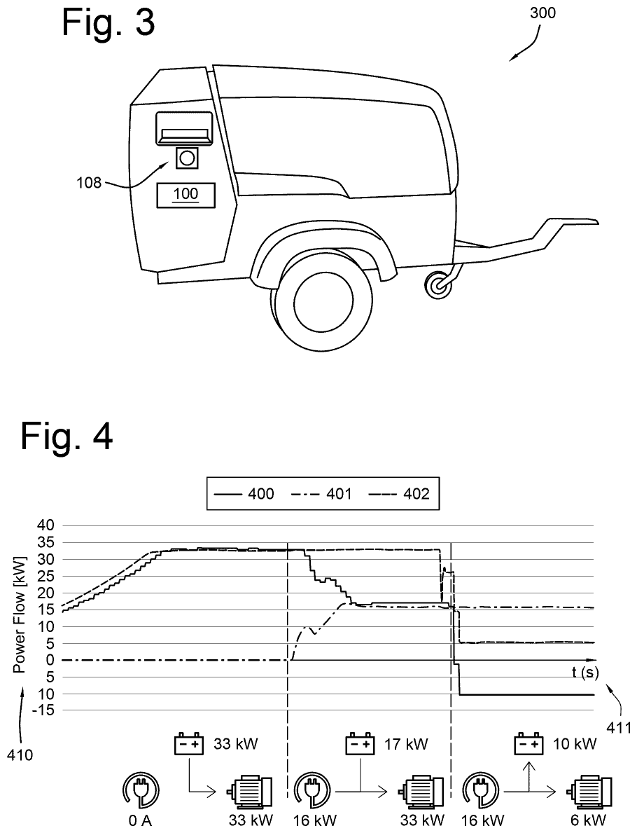

The arrangement as illustrated in FIG. 1 and FIG. 2 is then integrated into a mobile compressor 300 as illustrated in FIG. 3. In this case, a connection 108, for example a socket with a nominal current of 63 A, is provided to connect the compressor 300 to an external electricity grid. Furthermore, it is possible to have a user interface to operate the controller 100 and/or to read the status of the various components. A first example is the charge status of the set of batteries 109, 202, as well as the charge status of the batteries 109, 202. Other information that can be read is the pressure of the compressed gas, the rotational speed of the compressor element 107, and the total time during which the compressor 300 has been active.

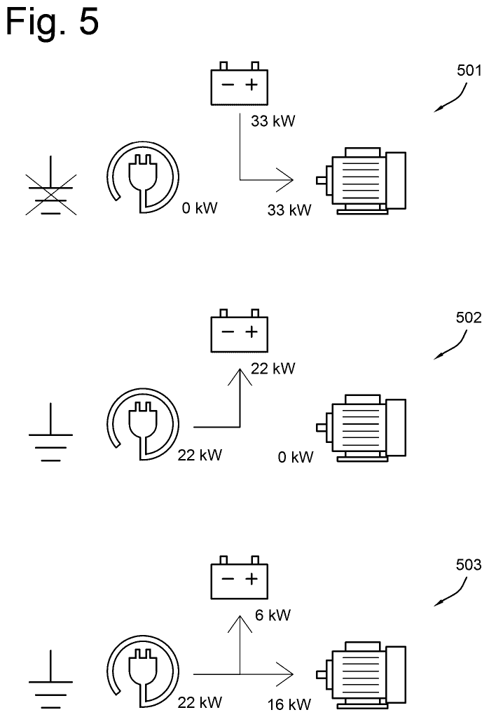

With reference to FIG. 5, the compressor 300 can also operate in different operating modes 501-503. A first operating mode 501 is the one wherein the compressor operates completely autonomously, in other words, wherein the electric motor fully withdraws the electric power, in this example 33 KW, from the set of batteries 109, 202. This situation can occur when there no electricity grid is available. The electrical power of 33 KW then corresponds to a maximum electrical current of 73.9 A, drawn from the set of batteries.

A second operating mode 502 is the one wherein the compressor 300 is not active, but where an electricity grid is available. In this case, the rechargeable batteries 109, 202 will be charged, in this example with a charging current 112 corresponding to a power of 22 kW. A charging current of a maximum of 49.3 A will then flow to the battery management system to charge the batteries 109, 202.

A third illustrated operating mode 503 is the one wherein an electricity grid is present and the compressor 300 is also active. A power of 22 KW can then be made available from the grid, as already explained, based on the power of on-board charger 103.

In this example, the electrical power for the electric motor 106 is 33 KW, as already mentioned, and the limited available power of 22 KW from the electricity grid 108 can be complemented with a power of 11 KW from the batteries 109, 202. This allows the motor to continue operating on the maximum power of 33 KW.

Finally, with reference to FIG. 4, an illustration is provided, based on a set of graphs of the course of the power flow, illustrated on the y-axis 410 in the unit of kW, over time on the x-axis in the unit of seconds. Graph 400 represents the power flow to and from the batteries 109, 202, graph 401 the electrical power withdrawn from the electricity grid via connection 108, and graph 402 the power that flows to the electric motor 106 for driving the compressor element 107.

On the left side of the illustration, an operating mode is shown wherein the electric motor 106 is driven entirely by power from the batteries 109, 202. This therefore corresponds to operating mode 501, as illustrated in FIG. 5. On the right side an illustration of an operating mode is shown wherein the electric motor 106 is driven and the batteries 109, 202 are charged. Finally, an operating mode between the left side and the right side of the illustration is shown wherein the electric motor 106 is driven with electrical power from both the electricity grid via connection 108 and the set of batteries 109, 202. This corresponds to an operating mode such as 503 as illustrated in FIG. 5.

1-17. (canceled)

18. A computer-implemented method for controlling an electrically powered mobile compressor comprising a compressor element, driven by an electric motor, for supplying a compressed gas at a predefined pressure and/or flow rate, the electric motor connected to an electrical distribution device for providing an electrical consumer current, the distribution device further comprising:
an on-board charger, configured to provide electrical power to the electrical distribution device from an electricity grid; and
a battery management system, configured to support power exchange between the distribution device and an assembly of one or more rechargeable batteries;
a controller, configured to coordinate a power exchange between the electricity grid, the assembly of one or more rechargeable batteries, and the electric motor;
the method comprising the step of, when a required power for the electric motor exceeds an available power from the electricity grid;
complementing the available power with power from the assembly of one or more rechargeable batteries,
limiting the required power for the electric motor when the state of charge is lower than a second predefined value,
the limiting step further comprises:
limiting the predefined pressure and/or flow rate,
determining a state of charge of the assembly of the one or more rechargeable batteries, indicative of a remaining power using the battery management system;
wherein the first predefined value is lower than the second predefined value, the step of completing takes place as long as the state of charge is higher than a first predefined value.

19. The computer-implemented method according to claim 18, wherein, when the electrical distribution device further comprises a connection for an electrical consumer, the method further comprises the step of, when the required power for the electrical motor and the electrical consumer exceeds the available power from the electricity grid:
limiting the required power for the electric motor when the state of charge is lower than the second predefined value.

20. An electrically powered mobile compressor comprising an electric motor for driving a compressor element for supplying a compressed gas at a predefined pressure and/or flow rate, the compressor further comprising an electrical connection for an electricity grid, the electric motor connected to an electrical distribution device, the electrical distribution device further comprising:
an on-board charger configured to provide electrical power to the electrical distribution device from the electricity grid; and
a battery management system configured to support power exchange between the distribution device and an assembly of one or more rechargeable batteries;
a controller, configured to coordinate a power exchange between the electricity grid, the assembly of one or more rechargeable batteries, and the electric motor;
the controller is further configured to control the battery management system such that, when a required power for the electric motor exceeds an available power from the electricity grid, the available power is complemented with a power from the assembly of one or more rechargeable batteries,
the controller is further configured to determine a state of charge of the assembly of the one or more rechargeable batteries, indicative of a remaining power, using the battery management system, and wherein the available power is complemented as long as the state of charge is higher than a first predefined value,
the controller is further configured to limit the power, required by the electric motor, when the state of charge is lower than a second predefined value,
the first predefined value is less than or equal to the second predefined value,
wherein the controller is further configured to limit the power, required for the electric motor, by limiting the predefined pressure and/or the flow rate.

21. The electrically powered mobile compressor according to claim 20, wherein the electrical distribution device further comprises a connection for an electrical consumer, and wherein the controller is further configured, when the required power for the electric motor exceeds the available power from the electricity grid, to limit an electric demand current of the electric consumer.
